(19) United States
(12) Patent Application Publication
(10) Pub. No.: US 2023/0094953 A1
(43) Pub. Date: Mar. 30, 2023

(54) VENTILATION SYSTEM FOR A CAMPER

(71) Applicant: MINK CAMPERS EHF., Gardabaer (IS)

(72) Inventor: Olafur Freyr HALLDORSSON, Reykjavik (IS)

(21) Appl. No.: 17/911,358

(22) PCT Filed: Mar. 15, 2021
(86) PCT No.: PCT/IS2021/050005

§ 371 Date: Sep. 13, 2022

(30) Foreign Application Priority Data
Mar. 13, 2020 (IS) IS 050293

(51) Int. Cl. B60H 1/00; B60P 3/36; B60H 1/24; B60H 1/26

(52) U.S. Cl. CPC B60H 1/00364; B60P 3/36; B60H 1/247; B60H 1/26

(57) ABSTRACT

The present invention relates to ventilation systems and solutions for caravan vehicles, sports campers of a teardrop caravan type and ventilation units for larger caravans and recreation vehicles. The ventilation system of the present invention is designed to draw air through the caravan or recreation vehicle during driving and to ventilate the whole caravan vehicle both below and above the floor interior.

### FIELD OF THE INVENTION

The present invention relates to ventilation system and device for towable caravan trailers. Moreover, the present invention provides a multi-component ventilation system for providing ventilation solutions for caravan vehicles and recreation vehicles.

### BACKGROUND OF THE INVENTION

Caravans, travel trailer and campers are terms used for a housing on wheels towed behind cars on roads to provide a more comfortable sleeping arrangement during camping trips than the use of a tent. Leisure caravans have been known for over a century and have been fashionable in different sizes at different times through the years.

Teardrop trailers were popular between 1930 and 1960 with a small body having a tear drop shape and wheels outside the body. The inside allowed for a mattress on the floor for two people to sleep on and some space for clothing and such, whereas a galley for cooking is usually arranged from the outside in the rear under a hatch. The teardrop trailers provided a lighter towing alternative to larger caravans giving people with smaller cars the opportunity to tow such a leisure vehicle. The teardrop shape of these trailers presented lower air resistance and a generally fashionable look.

WO09156727A1 discloses a small caravan trailer where the pod can be demounted from the trailer assembly by the user. The pod is releasably secured to the chassis of the trailer assembly and it is secured to the chassis by means of clip assemblies, which allow a user quickly and easily to release the pod and demount it from the trailer assembly without the use of tools and it is sufficiently portable to be readily carried by able-bodied people.

US2008211259A discloses a teardrop travel trailer having an airfoil shape with a leading-edge region at the front, a trailing edge region at the rear with two relatively flat opposite sides. The superior surface, extending from the leading-edge region to the trailing edge region, can be deployed from a travelling position into a roof for a habitat configuration by pivoting around a transversal axis located along the leading-edge region.

One of the problems with smaller caravan trailers designed to have a mattress covering the whole floor area is ventilation and condensation in the lower part of the housing, which causes the mattress to mold.

### SUMMARY OF THE INVENTION

The present invention relates to ventilation systems and solutions for caravan vehicles, sports campers of a teardrop caravan type and ventilation units for larger caravans and recreation vehicles. The ventilation system of the present invention is designed to draw air through the caravan or recreation vehicle during driving and to ventilate the whole caravan vehicle both below and above the floor interior. The individual components of the ventilation system together with the design of the housing itself provides a multi-functional solution for ventilating a caravan trailer and preventing condensation and mould in some components of the caravan trailer. The ventilation system of the present invention is provided through means for guiding airflow into the housing or a device which blows temperature-controlled air through the housing of the caravan or recreation vehicle during driving, where the temperature of the air blown into the housing is based on the climate the caravan is being used in. The system of the present invention uses channels formed in the structure of the housing to distribute ventilation air through the housing and a drain to exit humidity and condensate out of the housing.

The present invention further provides a ventilation unit which can be placed into side walls of larger caravan vehicles or even recreation vehicles. The ventilation unit of the present invention is designed to draw outside air into the housing of the caravan or recreation vehicle during driving through a suction formed by other non-airtight components or joining surfaces of the housings.

It is an object of the present invention to overcome or ameliorate the aforementioned drawbacks of the prior art and to provide an improved and/or alternative and/or additional system for providing ventilation for caravan trailers with means for blowing and distributing temperature-controlled air through the housing of the caravan trailer. It is one preferred object of the present invention to provide a system for ventilating caravan trailers providing an air inlet formed in the side walls of the caravan trailers with horizontal grooves having small apertures for air inlet. Moreover, it is a preferred object of the present invention to provide ventilation devices for caravan trailers or recreational vehicles which is implemented in the side walls of the caravan trailers or recreational vehicles where airflow through other non-airtight components or joining surfaces of the housing of the caravans or recreational vehicles provides ventilation through the ventilation device. Another preferred object of the present invention is to provide a system means for supplying and distributing temperature-controlled air through the housing of the caravan trailer in combination with an air inlet formed in the side walls of the caravan trailer for ventilation of the caravan vehicle.

The object(s) underlying the present invention is (are) particularly solved by the features defined in the independent claims. The dependent claims relate to preferred embodiments of the present invention. Further additional and/or alternative aspects and embodiments are discussed below.

Thus, at least one of the preferred objects of the present invention is solved by a ventilation system for a caravan trailer, where the caravan trailer comprises a housing, with a floor section, a space underneath the floor section and a door. The ventilation system for a caravan trailer further comprises a means for directing air flow into the housing, where the air is distributed through outlets and into different positions in the housing.

Another object of the present invention is solved by a ventilation system for a caravan trailer, wherein the caravan trailer comprises a housing being assembled from an outer shell and an inner panel and where the housing further comprises a door. The ventilation system further comprises an air inlet the side section of the housing, where the air inlet is formed by one or more essentially or substantially horizontal grooves in the outer shell having one or more ventilation openings being formed in the upper part of each of the at least one grooves.

Another object of the invention is solved by a ventilation device to be mounted in the side panel of a caravan trailer or recreational vehicles. The ventilation device comprises i) a frame, ii) an inner panel and an outer panel arranged in the frame, iii) one or more essentially or substantially horizontal grooves in the outer panel, where a ventilation openings are formed in the upper part of each of the at least one grooves and wherein the surface of the lower portion of each groove is formed to guide water and dust away from each groove, iv) a shield covering and matching an infolded area and opening in the inner panel, where the shield further comprising apertures or openings for letting air into the housing.

Another object of the invention is solved by a ventilation system for a caravan trailer, wherein the caravan trailer comprises a housing formed from inner panels and an outer shell, a floor section in the housing with a space underneath the floor section and a door. The caravan trailer further comprises a chassis on wheels, where the housing is mounted on the chassis. The ventilation system further comprises i) means for providing temperature controlled air flow for blowing air into the housing, where the temperature controlled air is blown through outlets to distribute the warm air into different positions in the housing, ii) channels for guiding or ventilating air from under the space under the whole floor section of the housing into the space above the floor section of the housing of the housing, and iii) an air inlet the side section of the housing having one or more essentially/substantially horizontal grooves in the outer shell where ventilation openings are formed in the upper part of each of the at least one groove and where the surface of the lower portion of the groove is formed to guide water and dust away from the groove.

### DESCRIPTION OF THE INVENTION

The following definitions and embodiments relate to the method, the apparatus of the invention.

In the present context the term “groove” refers to an inwardly extending indent or recess in a panel.

In an embodiment of the present invention the caravan trailer further comprises a chassis on wheels, where said housing is mounted on the chassis.

In an embodiment of the present invention the means for directing air flow into the housing is a device for providing temperature-controlled air flow into the housing, and wherein the temperature-controlled air is blown through outlets to distribute the air into the housing.

In an embodiment of the present invention the means for directing air flow into the housing comprises one or more air inlets for guiding air into the housing.

In an embodiment of the present invention the means for the means for directing air flow into the housing directs air into the space above and under the floor section of the housing.

In an embodiment of the present invention the space underneath the floor section allows flow of air under the whole floor section.

In an embodiment of the present invention the means for providing temperature-controlled air flow is Webasto.

In an embodiment of the present invention the means for providing temperature-controlled air flow 8 blows air into the space above and under the floor section of the housing.

In an embodiment of the present invention the floor section of the housing comprises a mattress and support for said mattress separating the space above and under the floor section.

In an embodiment of the present invention the support for the mattress of the floor section allows flow of air around the bottom surface of the mattress. Such support for a mattress may comprise a bar panel or grid panel for allowing ventilation of the mattress.

In an embodiment of the present invention the inner shell of the housing comprises channels for guiding (ventilating) air from under the space under the floor section of the housing into the space above the floor section of the housing of the housing.

In an embodiment of the present invention the system further comprises a drain at the bottom of the housing for exiting condense and liquid from the housing.

In an embodiment of the present invention the caravan trailer further comprises means for producing electricity.

In an embodiment of the present invention the means for producing electricity is a solar cell or an electric generator associated with the wheels of the caravan trailer.

In an embodiment of the present invention the means for producing electricity provides power for an electrical system of the caravan trailer or for the vehicle towing the caravan trailer.

In an embodiment of the present invention the surface of the lower portion of the groove is formed to guide water and out of the groove.

In an embodiment of the present invention the air inlet further comprises a shield covering and matching an indent and opening in the inner panel of said housing, said shield further comprising apertures/openings for letting air into the housing.

In an embodiment of the present invention the apertures/openings are positioned around the edges of the indent in the inner panel of said housing.

In an embodiment of the present invention the air inlet further comprises a lid with apertures/openings for the air intake.

In an embodiment of the present invention the air inlet further comprises a filter for keeping larger particles and insects out of the caravan.

In an embodiment of the present invention the lower portion of the groove, formed to guide water and dust away from the groove, has a concave or curved shape.

In an embodiment of the present invention the air inlet comprises a spacing between the shield and the back side of the one or more essentially/substantially horizontal indent/groove.

In an embodiment of the present invention the system further comprises a spoiler device to be placed in front of the device in the forward moving direction of the caravan trailer or recreational vehicle.

In an embodiment of the present invention the outer part of the groove is covered by a filter/net to prevent larger particles from entering the caravan through the air inlet.

In an embodiment of the present invention the air inlet allows air to flow in during driving due to intake of air through non-airtight surfaces of the housing and air-exchange when the camper is not moving.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a transactional side view of a caravan trailer outlining various components of the ventilation system of the invention.

FIG. 2 is a transactional side view of a caravan trailer demonstrating flow of air into and through the housing f the caravan trailer.

FIG. 3 is a diagonal transection view into a caravan trailer outlining some of the components of the ventilation system of the invention.

FIG. 4 is a schematic drawing of the airflow through an air inlet of the ventilation system of the present invention.

FIG. 5 is a perspective and transactional view of an air-inlet according to one embodiment of the invention.

FIG. 6 is a schematic drawing of a ventilation device to be mounted in the side panel of a caravan trailer or recreational vehicles.

### DETAILED DESCRIPTION OF THE PREFERRED EMBODIMENTS

In the following, exemplary embodiments of the invention will be described, referring to the figures. These examples are provided to provide further understanding of the invention, without limiting its scope.

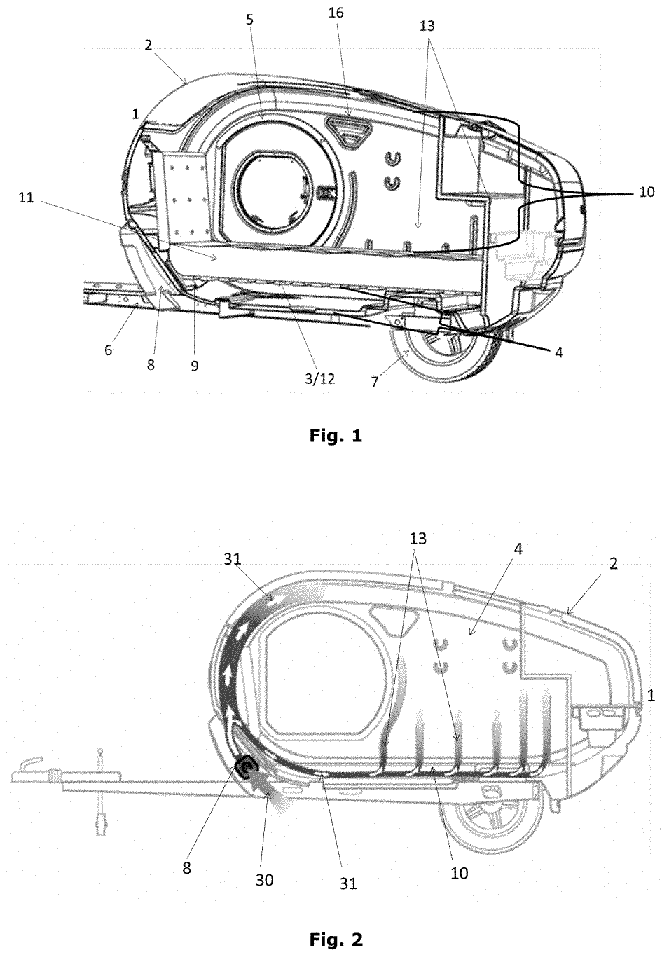

FIG. 1 shows a transactional side view of a caravan trailer 1 comprising a housing 2, where the housing has a floor section 3 and a space underneath 4 and above 10 the floor section 3 as well as a door 5. The housing is mounted on a chassis 6 on wheels 7. The floor section of the housing comprises a mattress 11 on a support structure 12 for the mattress, which separates the space above 10 and under 4 the floor section. The figure also shows a device or means for providing temperature-controlled air flow 8 for blowing air into the housing characterized in that the ventilation system for a caravan trailer further comprises a means for providing temperature-controlled air flow 8 for blowing air into the housing through outlets 9 to distribute the warm air into the space above 10 and under 4 the floor section of the housing. The figure also shows how channels or longitudinal grooves 13 are formed in the inner shell of the housing for guiding (ventilating) air from under the space under the floor section 4 of the housing into the space above the floor section 10 of the housing 2. An air inlet 14 is also shown in the upper portion of the side panel of the caravan.

FIG. 2 is transactional side view of a caravan trailer 1 showing the flow of air into and through the housing 2 of the caravan trailer 1. The floor section of the housing is not shown in this drawing but arrows 4 and 10 point to the space above 10 and under 4 the floor section of the housing. The means for providing temperature-controlled air flow 8 for blowing air into the housing 2 in the embodiment shown in FIG. 2 is a device for providing temperature-controlled airflow 8, such as a Webasto for distributing warm air/heated air 31, into different positions in the housing. The drawing shows how outside air 30 is taken into the device for providing temperature-controlled airflow 8 and warm air/heated 31 is blown underneath the floor section 10 and in the upper portion 4 of the housing 2. The drawing also shows the channels 13 formed in the inner panel 15 of the housing 2 for guiding (ventilating) air from under the space 10 under the floor section of the housing into the space above the floor section 4 of the housing 2.

FIG. 3 shows diagonal transection view of caravan trailer 1 disclosing the means for providing and distributing airflow through the inside of the caravan trailer. The drawing shows the means for providing temperature-controlled air flow 8 for blowing air into the housing 2 and the outlets 9 to for blowing temperature controlled into different positions in the housing. The drawing further outlines the channels 13 formed in the inner panel of the housing 2 for guiding temperature controlled from space underneath the floor section of the housing up into the space above the floor section of the housing. A drain 33 is shown in the bottom part of the housing for exiting moist and fluid which condensates in the bottom part of the housing.

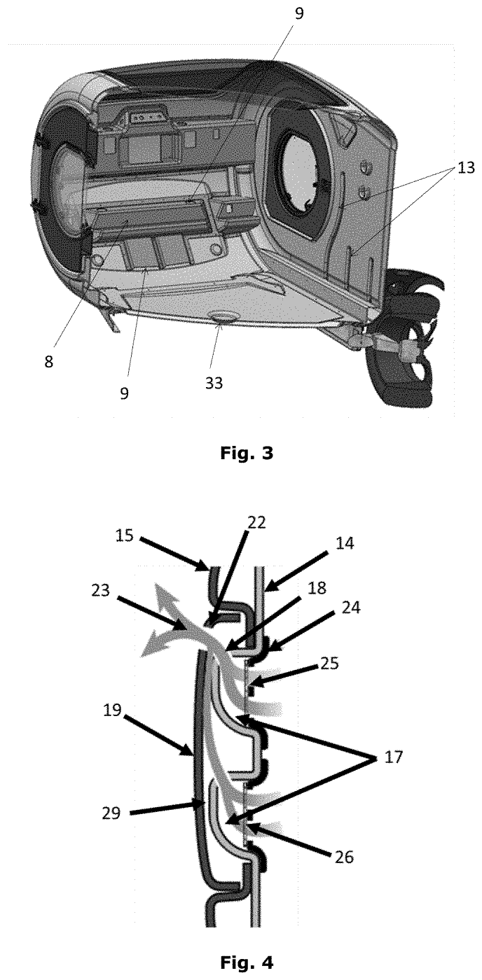

FIG. 4 shows the airflow through the air inlet 16 of the present invention. The airflow 23 finds a way through the air inlet 16 through the apertures or openings 25 of the lid 24 and through a filter 26, which can be placed behind the lid 24 for keeping larger particles and insects out of the caravan. the filter with on the outside of the caravan trailer for allowing air intake. A filter 26 can be placed behind the lid 24 for keeping larger particles and insects out of the caravan. The airflow 23 finds a through the outer shell 14 via ventilation openings 18 in the upper part of each of the grooves 17 and from the lower grooves 17 the air passes between the shield 19 and the back side of the one or more essentially/substantially horizontal indent/channel 17 via a spacing 29. The airflow 23 thereafter finds its way into the caravan trailer housing through apertures or openings 22 in shield 19, but the apertures or openings 22 are formed near the indent 20 in the inner panel 15 of the housing to fit the shield.

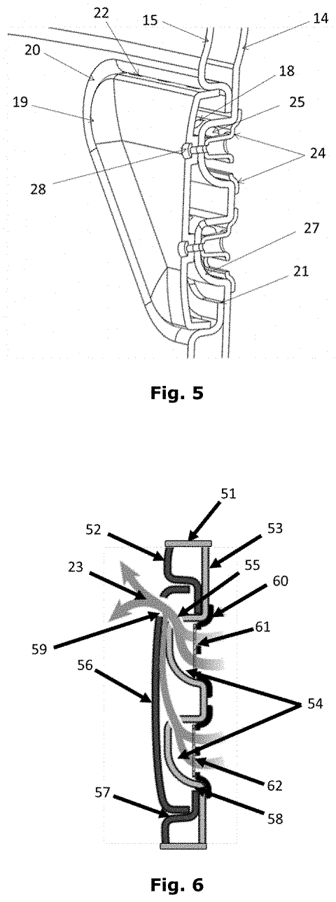

FIG. 5 is a perspective and transactional view of an air-inlet for a caravan trailer. The air inlet 16 shown in FIG. 5 is formed by two horizontal grooves 17 in the outer shell 14 of the housing. Ventilation openings 18 is/are formed in the upper part of each of the at least one groove, whereas the surface of the lower portion of the grooves are formed to guide water and dust away from the groove in a concave or curved 27 bend in the groove. The air inlet 16 is covered on the inside by a shield 19, where the shield matches or fits into an indent 20 and opening 21 in the inner panel 15 of the housing. The shield 19 has apertures or openings 22 around the edges of the indent 20 in the inner panel 15 of the housing 2 for providing a way for air 23 into the caravan trailer. The air inlet 16 is covered by a lid 24 with apertures/openings 25 on the outside of the caravan trailer for allowing air intake. The shield 19 is attached to the outer shell by a screw 28.

FIG. 6 shows a ventilation device which can be mounted in the side panel of a caravan trailer or recreational vehicles. The ventilation device 50, has a frame 51 and an inner panel 52 and an outer panel 53 arranged in the frame 51 for forming the housing of the ventilation device 50. The ventilation device 50 shown in this embodiment has two essentially/substantially horizontal grooves 54 in the outer panel 53 with ventilation openings 55 in the upper part of each of the two grooves 54. The ventilation device 50 has a major portion of its back side covered by a shield 56 matching or fitting into the infolded area 57 and covering the opening 58 in the inner panel 52, where the shield 55 also has apertures or openings 59 for letting air 23 into the housing. The drawing also shows how the apertures or openings 59 in the shield 56 are positioned around the edges of the infolded area 57 in the inner panel 52 of said device. The lid 60 covering the grooves 54 has apertures or openings 61 for the air intake and a filter 62 is also shown for keeping insects out.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. A ventilation system for a caravan trailer, wherein the caravan trailer comprises:
a housing, said housing further comprising:
a floor section,
space underneath the floor section, and
a door,
characterized in that the ventilation system for a caravan trailer further comprises a means for directing air flow into the housing, and wherein the air is distributed through outlets and into different positions in the housing.

2. The ventilation system according to claim 1, wherein the means for directing air flow into the housing is a device for providing temperature-controlled air flow into the housing, and wherein the temperature-controlled air is blown through outlets to distribute the air into the housing.

3. The ventilation system according to claim 1, wherein the means for directing air flow into the housing comprises one or more air inlets for guiding air into the housing.

4. The ventilation system according to claim 1, wherein the means for directing air flow into the housing directs air into the space above and under the floor section of the housing.

5. The ventilation system according to claim 1, wherein the space underneath the floor section allows flow of air under the whole floor section.

6. The ventilation system according to claim 5, wherein the floor section of the housing comprises a mattress and a support structure for said mattress separating the space above and under the floor section.

7. The ventilation system according to claim 6, wherein the support structure for the mattress of the floor section allows flow of air around the bottom surface of the mattress.

8. The ventilation system according to claim 1, wherein the inner shell of the housing comprises channels for guiding air from under the space under the floor section of the housing into the space above the floor section of the housing of the housing.

9. The ventilation system according to claim 1, wherein the system further comprises a drain at the bottom of the housing for exiting condense and liquid from the housing.

10. A ventilation system for a caravan trailer, wherein the caravan trailer comprises:
a housing being assembled from an outer shell and an inner panel, said housing further comprising a door,
characterized in that the ventilation system for a caravan trailer further comprises an air inlet in the side section of the housing, said air inlet is formed by one or more essentially horizontal groove in the outer shell, where a ventilation opening(s) is/are formed in the upper part of each of the at least one groove.

11. The ventilation system according to claim 10, wherein the surface of the lower portion of the groove is formed to guide water and out of the groove.

12. The ventilation system according to claim 10, wherein the air inlet further comprises a shield covering and matching an indent and opening in the inner panel of said housing, said shield further comprising apertures for letting air into the housing.

13. The ventilation system according to claim 12, wherein the apertures are positioned around the edges of the indent in the inner panel of said housing.

14. The ventilation system according to claim 10, wherein the air inlet further comprises a lid with apertures/openings for the air intake.

15. The ventilation system according to claim 10, wherein the air inlet further comprises a filter for keeping larger particles and insects out of the caravan.

16. The ventilation system according to claim 10, wherein the lower portion of the groove, formed to guide water and dust away from the groove, has a concave or curved shape.

17. The ventilation system according to claim 10, wherein the shield is attached to the outer shell by a screw.

18. The ventilation system according to claim 10, wherein the air inlet comprises a spacing between the shield and the back side of the one or more essentially horizontal groove.

19. The ventilation device according to claim 10, wherein the system further comprises a spoiler device to be placed in front of the air inlet in the forward moving direction of the caravan trailer or recreational vehicle.

20. The ventilation system according to claim 10, wherein the outer part of the groove is covered by a filter/net to prevent larger particles to enter the caravan through the air inlet.

21. A ventilation device to be mounted in the side panel of a caravan trailer or recreational vehicles, wherein the ventilation device comprises:
a frame
an inner panel and an outer panel arranged in said frame, characterized in that the ventilation device for a caravan trailer further comprises:
i) one or more essentially horizontal grooves in the outer panel, where a ventilation opening(s) is/are formed in the upper part of each of the at least one groove and wherein the surface of the lower portion of each groove is formed to guide water and dust away from the groove,
ii) a shield covering and matching an infolded area and opening in the inner panel, said shield further comprising apertures/openings for letting air into the housing.
